(19) United States
(12) Patent Application Publication
(10) Pub. No.: US 2022/0196413 A1
(43) Pub. Date: Jun. 23, 2022

(54) SYSTEMS AND METHODS FOR SIMULATING TRANSPORTATION ORDER BUBBLING BEHAVIOR

(71) Applicant: Beijing DiDi Infinity Technology and Development Co., Ltd., Beijing (CN)

(72) Inventors: Wenjie SHANG, BEIJING (CN); Qingyang LI, SUNNYVALE, CA (US); Zhiwei QIN, SAN JOSE, CA (US)

(21) Appl. No.: 17/124,704

(22) Filed: Dec. 17, 2020

(51) Int. Cl. G01C 21/34; G01C 21/36; G06Q 30/02; G06N 20/00

(52) U.S. Cl. CPC G01C 21/3438; G01C 21/3605; G06N 20/00; G06Q 30/0206; G06Q 30/0239; G01C 21/3484

(57) ABSTRACT

A method includes: selecting a current discount strategy according to a simulation result of a simulator of a machine learning model, wherein the simulation result comprises simulations of future transportation order bubbling in response to discounts given to current transportation order bubbling; obtaining a plurality of bubbling features of a transportation plan of a user, wherein the plurality of bubbling features comprise (i) a bubble signal comprising time information and location information corresponding to the transportation plan (ii) a supply and demand signal comprising transportation supply-demand information corresponding to the transportation plan, and (iii) a transportation order history signal of the user; determining a discount signal according to the plurality of bubbling features and the current discount strategy; and transmitting the discount signal to a computing device of the user.

### TECHNICAL FIELD

The disclosure relates generally to dispatching shared rides through a ride-sharing platform.

### BACKGROUND

Online ride-hailing platforms are rapidly becoming essential components of the modern transit infrastructure. Online ride-hailing platforms connect vehicles or vehicle drivers offering transportation services with users looking for rides. For example, a user may log into a mobile phone APP or a website of an online ride-hailing platform and submit a request for transportation service—the whole process can be referred to as bubbling. For example, a user may enter the starting and ending locations of a transportation trip and view the estimated price through bubbling.

The computing system of the online ride-hailing platform often needs user bubbling data to gauge the effects of various test policies. Performing such tests online in real-time is impractical because of its high cost and disruption to regular service. Thus, it is desirable to provide simulations of transportation order bubbling behavior.

### SUMMARY

Various embodiments of the specification include, but are not limited to, cloud-based systems, methods, and non-transitory computer-readable media for simulating transportation order bubbling.

In some embodiments, a computer-implemented method for simulating transportation order bubbling at a ride-hailing platform and applying the simulated transportation order bubbling comprises: selecting, by one or more computing devices, a current discount strategy according to a simulation result of a simulator of a machine learning model, wherein the simulation result comprises simulations of future transportation order bubbling in response to discounts given to current transportation order bubbling; obtaining, by the one or more computing devices, a plurality of bubbling features of a transportation plan of a user, wherein the plurality of bubbling features comprise (i) a bubble signal comprising time information and location information corresponding to the transportation plan, (ii) a supply and demand signal comprising transportation supply-demand information corresponding to the transportation plan, and (iii) a transportation order history signal of the user; determining, by the one or more computing devices, a discount signal according to the plurality of bubbling features and the current discount strategy; and transmitting, by the one or more computing devices, the discount signal to a computing device of the user.

In some embodiments, the location information comprises an origin location of the transportation plan of the user, a destination location of the transportation plan, a route departing from the origin location and arriving at the destination location; the time information comprises a timestamp, and a vehicle travel duration along the route; the bubble signal further comprises a price quote corresponding to the transportation plan; and the transportation supply-demand information comprises a number of passenger-seeking vehicles around the origin location, and a number of vehicle-seeking transportation orders departing from the origin location.

In some embodiments, the origin location of the transportation plan of the user comprises a geographical positioning signal of the computing device of the user; and obtaining the supply and demand signal comprises: obtaining, from a plurality of computing devices of a plurality of vehicle drivers, a plurality of geographical positioning signals respectively corresponding to the plurality of computing devices of the plurality vehicle drivers; and determining the number of passenger-seeking vehicles around the origin based on the plurality of geographical positioning signals and the geographical positioning signal of the computing device of the user.

In some embodiments, the geographical positioning signal comprises a Global Positioning System (GPS) signal; and the plurality of geographical positioning signals comprise a plurality of GPS signals.

In some embodiments, the transportation order history signal of the user comprises one or more of the following: a frequency of order transportation order bubbling by the user; a frequency of transportation order completion by the user; a history of discount offers provided to the user in response to the order transportation order bubbling; and a history of responses of the user to the discount offers.

In some embodiments, selecting the current discount strategy according to the simulation result of the simulator of the machine learning model comprises: collecting recent transportation order bubbling data, wherein the recent transportation order bubbling data comprises a plurality of bubbling features of a plurality of transportation plans of a plurality of users; respectively evaluating a plurality of candidate discount strategies by setting a target evaluation time period, feeding each strategy-data pair to the simulator to simulate transportation order bubbling within the target evaluation time period under influence of one or more previous discounts, and obtaining from the simulator a total revenue income to the ride-hailing platform within the target evaluation time period under each of the plurality of candidate discount strategies, wherein the strategy-data pair comprises one of the plurality of candidate discount strategies and the recent transportation order bubbling data; and selecting the current discount strategy from the plurality of candidate discount strategies by maximizing the total revenue income to the ride-hailing platform within the target evaluation time period.

In some embodiments, each of the plurality of candidate discount strategies comprises a plurality of discount policies each corresponding to a discount rate.

In some embodiments, the method further comprises iteratively performing the following steps until a consecutive period of time ends: in a current iteration, receiving, by the simulator, a first input comprising a first plurality of bubbling features (x₁) of a first transportation plan bubbling on a first day within the consecutive period of time; determining, by the simulator based on the first input and a candidate discount strategy, a first discount vector (c₁); generating, by the simulator, based on the first input, a second plurality of bubbling features (x₂) of a second transportation plan bubbling on a second day within the consecutive period of time; and generating, by the simulator, based on the first input and the first discount vector (c₁), a first number of gap days (a₁) between the first and the second days, wherein a first output of the simulator comprises the second plurality of bubbling features (x₂) and the first number of gap days (a₁), and the first output is a second input of the simulator in a next iteration.

In some embodiments, the simulator is configured to iteratively performing the following steps until a consecutive period of time ends: in a current iteration, receiving a first input comprising a first plurality of bubbling features (x₁) of a first transportation plan bubbling on a first day within the consecutive period of time; determining, based on the first input and a candidate discount strategy, a first discount vector (c₁); generating, based on the first input, a second plurality of bubbling features (x₂) of a second transportation plan bubbling on a second day within the consecutive period of time; and generating, based on the first input and the first discount vector (c₁), a first number of gap days (a₁) between the first and the second days, wherein a first output of the simulator comprises the second plurality of bubbling features (x₂) and the first number of gap days (a₁), and the first output is a second input of the simulator in a next iteration.

In some embodiments, the method further comprises: based on historical ride-hailing data, generating, by the one or more computing devices, simulation data comprising a t^{th} plurality of bubbling features (xₜ) of a t^{th} transportation plan of a test user bubbling on a day within a consecutive period of time, a t^{th} discount (cₜ) provided to the t^{th} transportation plan, a t^{th} number of gap days (aₜ) from the day until a (t+1)^{th} transportation plan of the test user bubbling on a different day within the consecutive period of time, and a (t+1)^{th} plurality of bubbling features (xₜ₊₁) of a (t+1)^{th} transportation plan bubbling on the different day within the consecutive period of time, wherein t is a natural number; and training, by the one or more computing devices, the machine learning model by minimizing a difference between the simulation data and the historical ride-hailing data.

In some embodiments, the simulator comprises a passenger behavior policy model (πᵤₛₑᵣ) and a feature generator model (T_{bubble}); the simulator is configured to generate the t^{th} number of gap days (aₜ) by feeding the t^{th} plurality of bubbling features (xₜ) and the t^{th} discount (cₜ) to the passenger behavior policy model (πᵤₛₑᵣ); and the simulator is configured to generate the (t+1)^{th} plurality of bubbling features (xₜ₊₁) by feeding the t^{th} plurality of bubbling features (xₜ), the t^{th} discount (cₜ), and the t^{th} number of gap days (aₜ) to the feature generator model (T_{bubble}).

In some embodiments, the passenger behavior policy model (πᵤₛₑᵣ) comprises a first encoder and a first decoder; the feature generator model (T_{bubble}) comprises a second encoder and a second decoder; the first encoder is configured to compress the t^{th} plurality of bubbling features (xₜ) and the t^{th} discount vector (cₜ) and map the t^{th} plurality of bubbling features (xₜ) and the t^{th} discount vector (cₜ) to a hidden variable space (zᵤ); the first decoder is configured to receive the hidden variable space (zᵤ) and the t^{th} discount vector (cₜ) and decode the hidden variable space (zᵤ) to output the t^{th} number of gap days (aₜ); the second encoder is configured to compress the t^{th} plurality of bubbling features (xₜ), the t^{th} discount vector (cₜ), and the t^{th} number of gap days (aₜ) and map the t^{th} plurality of bubbling features (xₜ), the t^{th} discount vector (cₜ), and the t^{th} number of gap days (aₜ) to a different hidden variable space (zₜ), and the second decoder is configured to receive the different hidden variable space (zₜ), the t^{th} discount vector (cₜ), and the t^{th} number of gap days (aₜ) and decode the different hidden variable space (zₜ) to output the (t+1)^{th} plurality of bubbling features (xₜ₊₁).

In some embodiments, training the machine learning model comprises: training the feature generator model (T_{bubble}) and the passenger behavior policy model (πᵤₛₑᵣ) respectively based on a conditional variational autoencoder (CVAE) algorithm.

In some embodiments, the method further comprises presenting, by the computing device of the user, the discount signal, the route, and the price quote.

In some embodiments, the method further comprises receiving, by the one or more computing devices, from the computing device of the user, an acceptance signal comprising an acceptance of the transportation plan of the user, the price quote, and a price discount corresponding to the discount signal; and transmitting, by the one or more computing devices, the transportation plan to a computing device of a vehicle driver for fulfilling the transportation order.

In some embodiments, one or more non-transitory computer-readable storage media stores instructions executable by one or more processors, wherein execution of the instructions causes the one or more processors to perform operations comprising: selecting a current discount strategy according to a simulation result of a simulator of a machine learning model, wherein the simulation result comprises simulations of future transportation order bubbling in response to discounts given to current transportation order bubbling; obtaining a plurality of bubbling features of a transportation plan of a user, wherein the plurality of bubbling features comprise (i) a bubble signal comprising time information and location information corresponding to the transportation plan, (ii) a supply and demand signal comprising transportation supply-demand information corresponding to the transportation plan, and (iii) a transportation order history signal of the user; determining a discount signal according to the plurality of bubbling features and the current discount strategy; and transmitting the discount signal to a computing device of the user.

In some embodiments, a system comprises one or more processors and one or more non-transitory computer-readable memories coupled to the one or more processors and configured with instructions executable by the one or more processors to cause the system to perform operations comprising: selecting a current discount strategy according to a simulation result of a simulator of a machine learning model, wherein the simulation result comprises simulations of future transportation order bubbling in response to discounts given to current transportation order bubbling; obtaining a plurality of bubbling features of a transportation plan of a user, wherein the plurality of bubbling features comprise (i) a bubble signal comprising time information and location information corresponding to the transportation plan, (ii) a supply and demand signal comprising transportation supply-demand information corresponding to the transportation plan, and (iii) a transportation order history signal of the user; determining a discount signal according to the plurality of bubbling features and the current discount strategy; and transmitting the discount signal to a computing device of the user.

In some embodiments, a computer system includes a selecting module configured to select a current discount strategy according to a simulation result of a simulator of a machine learning model, wherein the simulation result comprises simulations of future transportation order bubbling in response to discounts given to current transportation order bubbling; an obtaining module configured to obtain a plurality of bubbling features of a transportation plan of a user, wherein the plurality of bubbling features comprise (i) a bubble signal comprising time information and location information corresponding to the transportation plan, (ii) a supply and demand signal comprising transportation supply-demand information corresponding to the transportation plan, and (iii) a transportation order history signal of the user; a determining module configured to determine a discount signal according to the plurality of bubbling features and the current discount strategy; and a transmitting module configured to transmit the discount signal to a computing device of the user.

These and other features of the systems, methods, and non-transitory computer-readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the specification. It is to be understood that the foregoing general description and the following detailed description are exemplary and explanatory only, and are not restrictive of the specification, as claimed.

### BRIEF DESCRIPTION OF THE DRAWINGS

Non-limiting embodiments of the specification may be more readily understood by referring to the accompanying drawings in which:

FIG. 1A illustrates an exemplary system for simulating transportation order bubbling, in accordance with various embodiments of the disclosure.

FIG. 1B illustrates an exemplary system for simulating transportation order bubbling, in accordance with various embodiments of the disclosure.

FIG. 2A illustrates an exemplary method for simulating transportation order bubbling, in accordance with various embodiments of the disclosure.

FIG. 2B illustrates exemplary operations of a passenger behavior policy model, in accordance with various embodiments.

FIG. 2C illustrates exemplary operations of a bubble feature generator model, in accordance with various embodiments of the disclosure.

FIG. 3A illustrates an exemplary simulator for simulating and training transportation order bubbling, in accordance with various embodiments.

FIG. 3B illustrates an exemplary comparison between the output distribution of the passenger behavior policy model and the distribution of real data, in accordance with various embodiments.

FIG. 3C illustrates an exemplary simulated distribution of passenger interval days of two adjacent bubbles under six different discounts, in accordance with various embodiments.

FIG. 3D illustrates an exemplary real distribution of passenger interval days of two adjacent bubbles under six different discounts, in accordance with various embodiments.

FIG. 3E illustrates an exemplary comparison of the transition distribution mean between the simulated data from the bubble feature generator model and the real-world test data, in accordance with various embodiments.

FIG. 3F illustrates an exemplary comparison of the transition distribution standard deviation between the simulated data from the bubble feature generator model and the real-world test data, in accordance with various embodiments.

FIG. 3G illustrates an exemplary comparison of the transition distribution mean error between the simulated data from the bubble feature generator model and the real-world test data, in accordance with various embodiments.

FIG. 3H illustrates an exemplary comparison of the transition distribution standard deviation error between the simulated data from the bubble feature generator model and the real-world test data, in accordance with various embodiments.

FIG. 3I illustrates the trending of the passengers' average bubble frequency increasing rate with respect to the preset discount rate, in accordance with various embodiments.

FIG. 3J illustrates the trending of the simulated discount rate with respect to the preset discount rate, in accordance with various embodiments.

FIG. 3K illustrates the trending of the passengers' order number increasing rate with respect to the preset discount rate, in accordance with various embodiments.

FIG. 3L illustrates the trending of the simulated ROI with respect to the preset discount rate, in accordance with various embodiments.

FIG. 3M illustrates the trending of GMV increasing rate with respect to the preset discount rate, in accordance with various embodiments.

FIG. 3N illustrates the trending of the simulated discount bubble proportion with respect to the preset discount rate, in accordance with various embodiments.

FIG. 4 illustrates an exemplary method for simulating transportation order bubbling, in accordance with various embodiments.

FIG. 5 illustrates an exemplary system for simulating transportation order bubbling, in accordance with various embodiments.

FIG. 6 illustrates a block diagram of an exemplary computer system in which any of the embodiments described herein may be implemented.

### DETAILED DESCRIPTION

Non-limiting embodiments of the present specification will now be described with reference to the drawings. Particular features and aspects of any embodiment disclosed herein may be used and/or combined with particular features and aspects of any other embodiment disclosed herein. Such embodiments are by way of example and are merely illustrative of a small number of embodiments within the scope of the present specification. Various changes and modifications obvious to one skilled in the art to which the present specification pertains are deemed to be within the spirit, scope, and contemplation of the present specification as further defined in the appended claims.

In various embodiments, a user may log into a mobile phone APP or a website of an online ride-hailing platform and submit a request for transportation service—which can be referred to as bubbling. For example, a user may enter the starting and ending locations of a transportation trip and view the estimated price through bubbling. Bubbling takes place before the acceptance and submission of an order of the transportation service. After receiving the estimated price (with or without a discount), the user may accept the order or reject the order. If the order is accepted and submitted, the online ride-hailing platform may match a vehicle with the submitted order.

The computing system of the online ride-hailing platform often needs user bubbling data to gauge the effects of various test policies. Performing such tests online in real-time is impractical for its high cost and disruption to regular service. Thus, it is desirable to provide simulations of transportation order bubbling behavior, which improves the function of the computing system by simulating such bubbling behavior. The improvements may include, for example, an increase in computing speed because simulation takes a much shorter time than real-time on-line testing (e.g., simulation can quickly generate bubbling behaviors that may otherwise take days or weeks of data collection through real-time on-line testing), an improvement in data collection because real-time on-line testing can only output results under one set of conditions while simulation can generate results under different sets of conditions for the same subject, etc.

In some embodiments, the test policies may include a discount policy. When a user bubbles, the online ride-hailing platform may monitor the bubbling behavior in real-time and determine whether to push a discount to the user. The online ride-hailing platform may, by calling a model, select an appropriate discount or not offer any discount, and output the result to the user's device interface. A discount received by the user may encourage the passenger to proceed from bubbling to submitting the transportation order.

In some embodiments, in the long term, the discount policy may affect the user's bubble frequency over a long period (e.g., days, weeks, months). That is, the current bubble discount may stimulate the user to generate more bubbles in the future. It is, therefore, desirable to model the patterns of user bubble frequency under different discount policies. It will help improve the discount policy, promote the growth of platform GMV (gross merchandise value), and minimize cost.

In some embodiments, Passenger Relationship Management (PRM) focuses on optimizing strategies to maximize long-term passenger value. From a long-term perspective, the long-term value of passengers is largely determined by how often they bubble. Take the example of bubble scenarios in the online ride-hailing platform, conventional strategies aimed at optimizing the selection of discount on the bubble behaviors which happened already, and then using the static data to train the optimized policy. However, it does not take into account the influence of the discount on the future bubble frequency of the user. Thus, the conventional strategies are inaccurate for not accounting for long-term impact.

To at least address the issues discussed above, in some embodiments, by formalizing the bubble sequence as a Markov Decision Process (MDP), the disclosure provides systems and methods to simulate the change of user bubble frequency under different platform policies such as discounts. In some embodiments, two conditional variational autoencoder (VAE) models are trained for a sequential simulation. One is the passenger behavior policy model, which outputs the number of interval days until the next bubble. The other is a feature generator of the next bubble, which plays a role of the state transition model. In some embodiments, through the way of MDP simulation, a simulator is constructed to evaluate the subsidy policies in the view of long-term profits. The simulator may be used to compare the performances of different policies directly, thereby helping to optimize strategies to maximize long-term value to the ride-hailing platform.

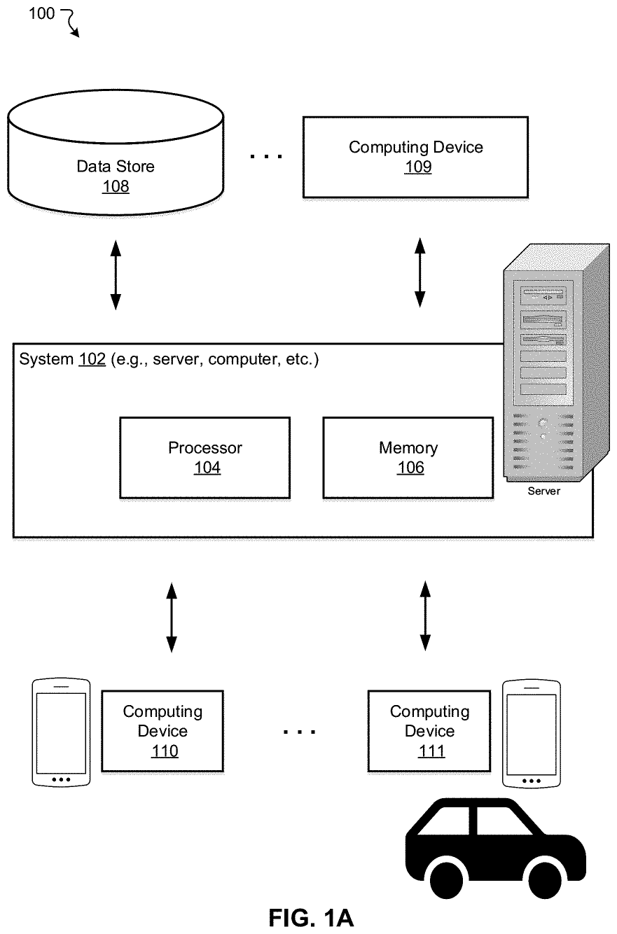

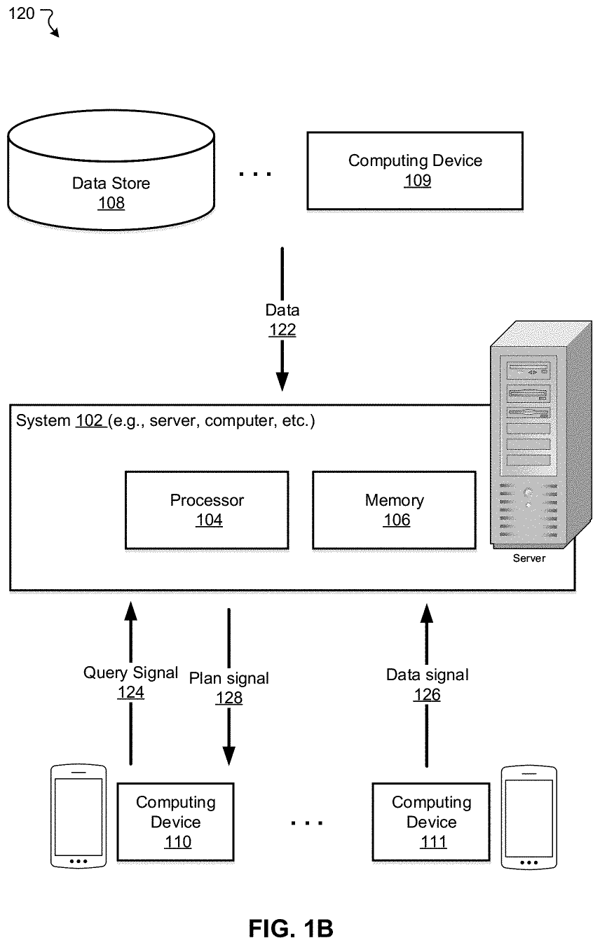

FIG. 1A illustrates an exemplary system 100 for simulating transportation order bubbling, in accordance with various embodiments. The operations shown in FIG. 1A and presented below are intended to be illustrative. As shown in FIG. 1A, the exemplary system 100 may comprise at least one computing system 102 that includes one or more processors 104 and one or more memories 106. The memory 106 may be non-transitory and computer-readable. The memory 106 may store instructions that, when executed by the one or more processors 104, cause the one or more processors 104 to perform various operations described herein. The system 102 may be implemented on or as various devices such as mobile phones, tablets, servers, computers, wearable devices (smartwatches), etc. The system 102 above may be installed with appropriate software (e.g., platform program, etc.) and/or hardware (e.g., wires, wireless connections, etc.) to access other devices of the system 100.

The system 100 may include one or more data stores (e.g., a data store 108) and one or more computing devices (e.g., a computing device 109) that are accessible to the system 102. In some embodiments, the system 102 may be configured to obtain data (e.g., historical ride-hailing data such as location, time, and fees for multiple historical vehicle transportation trips) from the data store 108 (e.g., a database or dataset of historical transportation trips) and/or the computing device 109 (e.g., a computer, a server, or a mobile phone used by a driver or passenger that captures transportation trip information such as time, location, and fees). The system 102 may use the obtained data to train a model for simulating transportation order bubbling. The location may be transmitted in the form of GPS (Global Positioning System) coordinates or other types of positioning signals. For example, a computing device with GPS capability and installed on or otherwise disposed in a vehicle may transmit such location signal to another computing device (e.g., a computing device of the system 102).

The system 100 may further include one or more computing devices (e.g., computing devices 110 and 111) coupled to the system 102. The computing devices 110 and 111 may include devices such as cellphones, tablets, in-vehicle computers, wearable devices (smartwatches), etc. The computing devices 110 and 111 may transmit or receive signals (e.g., data signals) to or from the system 102.

In some embodiments, the system 102 may implement an online information or service platform. The service may be associated with vehicles (e.g., cars, bikes, boats, airplanes, etc.), and the platform may be referred to as a vehicle platform (alternatively as service hailing, ride-hailing, or ride order dispatching platform). The platform may accept requests for transportation service, identifying vehicles to fulfill the requests, arranging passenger pick-ups, and process transactions. For example, a user may use the computing device 110 (e.g., a mobile phone installed with a software application associated with the platform) to request a transportation trip arranged by the platform. The system 102 may receive the request and relay it to one or more computing device 111 (e.g., by posting the request to a software application installed on mobile phones carried by vehicle drivers or installed on in-vehicle computers). Each vehicle driver may use the computing device 111 to accept the posted transportation request and obtain pick-up location information. Fees (e.g., transportation fees) may be transacted among the system 102 and the computing devices 110 and 111 to collect trip payment and disburse driver income. Some platform data may be stored in the memory 106 or retrievable from the data store 108 and/or the computing devices 109, 110, and 111. For example, for each trip, the location of the origin and destination (e.g., transmitted by the computing device 110), the fee, and the time may be collected by the system 102.

In some embodiments, the system 102 and the one or more of the computing devices (e.g., the computing device 109) may be integrated in a single device or system. Alternatively, the system 102 and the one or more computing devices may operate as separate devices. The data store(s) may be anywhere accessible to the system 102, for example, in the memory 106, in the computing device 109, in another device (e.g., network storage device) coupled to the system 102, or another storage location (e.g., cloud-based storage system, network file system, etc.), etc. Although the system 102 and the computing device 109 are shown as single components in this figure, it is appreciated that the system 102 and the computing device 109 can be implemented as a single device or multiple devices coupled together. The system 102 may be implemented as a single system or multiple systems coupled to each other. In general, the system 102, the computing device 109, the data store 108, and the computing device 110 and 111 may be able to communicate with one another through one or more wired or wireless networks (e.g., the Internet) through which data can be communicated.

FIG. 1B illustrates an exemplary system 120 for simulating transportation order bubbling, in accordance with various embodiments. The operations shown in FIG. 1B and presented below are intended to be illustrative. In various embodiments, the system 102 may obtain data 122 (e.g., historical data) from the data store 108 and/or the computing device 109. The historical data may comprise, for example, historical vehicle trajectories and corresponding trip data such as time, origin, destination, fee, etc. Some of the historical data may be used as training data for training models. The obtained data 122 may be stored in the memory 106. The system 102 may train a model with the obtained data 122.

In some embodiments, the computing device 110 may transmit a signal (e.g., query signal 124) to the system 102. The computing device 110 may be associated with a passenger seeking transportation service. The query signal 124 may correspond to a bubble signal comprising information such as a current location of the vehicle, a current time, an origin of a planned transportation, a destination of the planned transportation, etc. In the meanwhile, the system 102 may have been collecting data (e.g., data signal 126) from each of a plurality of computing devices such as the computing device 111. The computing device 111 may be associated with a driver of a vehicle described herein (e.g., taxi, a service-hailing vehicle). The data signal 126 may correspond to a supply signal of a vehicle available for providing transportation service.

In some embodiments, the system 102 may obtain a plurality of bubbling features of a transportation plan of a user. For example, bubbling features of a user bubble may include (i) a bubble signal comprising a timestamp, an origin location of the transportation plan of the user, a destination location of the transportation plan, a route departing from the origin location and arriving at the destination location, a vehicle travel duration along the route, and/or a price quote corresponding to the transportation plan, (ii) a supply and demand signal comprising a number of passenger-seeking vehicles around the origin location, and a number of vehicle-seeking transportation orders departing from the origin location, and (iii) a transportation order history signal of the user. The bubble signal may be collected from the query signal 124 and/or other sources such as the data stores 108 and the computing device 109 (e.g., the timestamp may be obtained from the computing device 109) and/or generated by itself (e.g., the route may be generated at the system 102). The supply and demand signal may be collected from the query signal of a computing device of each of multiple users and the data signal of a computing device of each of multiple vehicles. The transportation order history signal may be collected from the computing device 110 and/or the data store 108. In one embodiment, the vehicle may be an autonomous vehicle, and the data signal 128 may be collected from an in-vehicle computer.

In some embodiments, when making the assignment, the system 102 may send a plan (e.g., plan signal 128) to the computing device 110 or one or more other devices. The plan signal 128 may include a price quote, a discount signal, the route departing from the origin location and arriving at the destination location, an estimated time of arrival at the destination location, etc. The plan signal may be presented on the computing device 110 for the user to accept or reject.

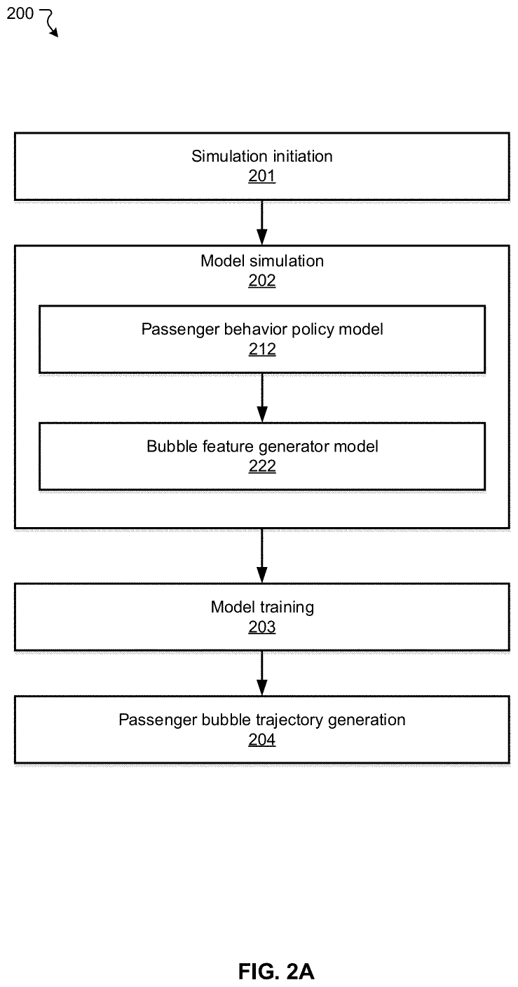

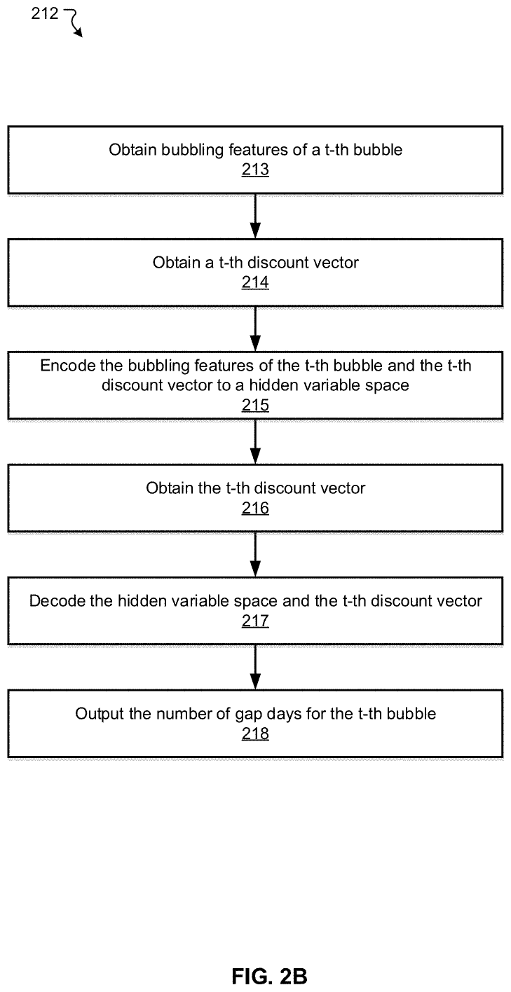

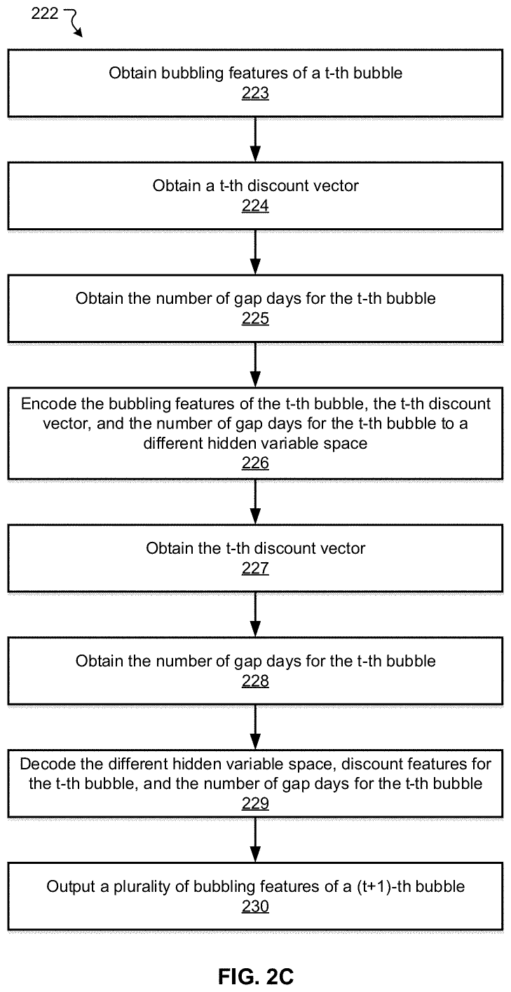

FIG. 2A illustrates an exemplary method 200 for simulating transportation order bubbling, in accordance with various embodiments. The method 200 may be implemented in various environments including, for example, by the system 100 of FIG. 1A and FIG. 1B. The exemplary method 200 may be implemented by one or more components of the system 102. For example, a non-transitory computer-readable storage medium (e.g., the memory 106) may store instructions that, when executed by a processor (e.g., the processor 104), cause the system 102 (e.g., the processor 104) to perform the method 200. The operations of method 200 presented below are intended to be illustrative. The operations shown in FIG. 2A and presented below are intended to be illustrative. Depending on the implementation, the exemplary method 200 may include additional, fewer, or alternative steps performed in various orders or in parallel.

In some embodiments, the simulation initiation 201 may include initiating generation of a bubble trajectory (e.g., the sequence of a user's bubble behavior within a consecutive period of time) from the perspective of MDP. The consecutive period of time may be any duration of time such as 14 days, one month, etc. Interval days of two adjacent bubbles may be used to (i) indirectly describe how the subsidy policy affects the user's bubble frequency (that is, how the subsidy policy affects the interval days of two adjacent bubbles of the user), and (ii) build a generative model to sample a plurality of next bubbling features. Therefore, the simulated trajectory length may be the user's bubble frequency over a consecutive period of time.

In some embodiments, model simulation 202 may include simulating the state transition process of each bubble behavior (referred to as a step) in the passenger's bubble trajectory. In one embodiment, two models are built in model formulation 202. The model simulation 202 may include two sub-steps. First, the number of gap days until a next bubble aₜ at step t is obtained through a passenger behavior policy model πᵤₛₑᵣ 901. Second, a plurality of next bubbling features xₜ₊₁ are generated by sampling from a bubble feature generator model T_{bubble} 902. A day feature dₜ (e.g., which day within the consecutive period of time) is included in the plurality of bubbling features xₜ. When the next bubble day feature dₜ₊₁=dₜ+aₜ exceeds the present consecutive period of time of a trajectory, the trajectory ends. Otherwise, a state transition quad {xₜ, cₜ, aₜ, xₜ₊₁} is constructed, and the simulation of a passenger trajectory is completed by looping such transition process. Further details of the passenger behavior policy model πᵤₛₑᵣ 901 and the bubble feature generator model T_{bubble}, 902 are described below with reference to FIG. 2B to FIG. 5.

In some embodiments, model training 203 may include training the passenger behavior policy model πᵤₛₑᵣ and the bubble feature generator model T_{bubble} based on the Conditional VAE (CVAE) algorithm. A supervised learning data set is constructed utilizing historical bubble data to train the above two models until the simulated error falls under a threshold value.

In some embodiments, after the above two models are trained through supervised learning, passenger bubble trajectory generation 204 may include generating one or more passenger bubble trajectories for each of one or more subsidy policies according to the simulation process in model simulation 202. The generated bubble trajectories are then used as a passenger bubble frequency simulator to evaluate the subsidy policies. Additionally, an offline A/B test can be conducted by simulating a blank strategy to compare performances of different subsidy policies in a long period of time, so as to realize the rapid offline evaluation and optimization of subsidy policies.

FIG. 2B illustrates exemplary operations of a passenger behavior policy model πᵤₛₑᵣ in accordance with various embodiments. The operations 212 may be implemented in various environments including, for example, by the system 100 of FIG. 1A and FIG. 1B. The operations 212 may be implemented by one or more components of the system 102. For example, a non-transitory computer-readable storage medium (e.g., the memory 106) may store instructions that, when executed by a processor (e.g., the processor 104), cause the system 102 (e.g., the processor 104) to perform the operations 212. The operations 212 presented below are intended to be illustrative. The operations shown in FIG. 2B and presented below are intended to be illustrative. Depending on the implementation, the operations 212 may include additional, fewer, or alternative steps performed in various orders or in parallel.

In some embodiments, step 213 includes obtaining a plurality of bubbling features of a t-th bubble xₜ. For example, for the first bubble, step 214 includes obtaining a first plurality of bubbling features of a first bubble, denoted as x₁, of a first transportation plan bubbling on a first day within the consecutive period of time. The plurality of bubbling features of the first bubble-x₁ may include: the characteristics of estimated price, duration and distance of the bubble trip, the information of supply and demand of the region where the trip starts, and the statistical characteristics of the passenger's bubble, order sending and order completion in the recent period. The plurality of bubbling features of the first bubble x₁ may also include a day feature d₁, which denotes the first day within the consecutive period of time.

In some embodiments, step 214 includes obtaining a t-th discount vector cₜ according to a subsidy policy model. For example, for the first bubble, step 214 includes obtaining a first discount vector c₁ according to the subsidy policy model. The subsidy policy model may select any number of discounts from a candidate discount strategy. The candidate discount strategy may include any possible discounts available. For instance, in the test set, 6 kinds of discounts may be selected: 25% discount, 20% discount, 15% discount, 10% discount, 5% discount, and no discount. In this case, the first discount vector c₁ is a six dimensional vector encoded in the form of one hot and reflects all 6 discounts. Once the discounts are selected, the discount vector remains the same for the t-th discount vector cₜ.

In some embodiments, step 215 includes encoding the plurality of bubbling features of the t-th bubble xₜ and the t-th discount vector cₜ to a t-th hidden variable space zᵤ. For example, for the first bubble, step 215 includes encoding the plurality of bubbling features of the first bubble x₁ and discount features for the first discount vector c₁ to a hidden variable space zᵤ₁.

In some embodiments, step 216 includes obtaining the t-th discount vector cₜ according to a subsidy policy model. For example, for the first bubble, step 214 includes obtaining the discount features for the first discount vector c₁ according to the subsidy policy model.

In some embodiments, step 217 includes decoding the t-th hidden variable space and the t-th discount vector cₜ to output a first number of gap days aₜ until the passenger's next bubble. For example, for the first bubble, step 217 includes decoding the hidden variable space zᵤ₁ and the first discount vector c₁ to output a first number of gap days a₁ until the passenger's next bubble.

In some embodiments, step 218 includes outputting a t-th number of gap days aₜ. For example, for the first bubble, step 218 includes outputting the first number of gap days a₁ until the passenger's next bubble, and stores it in the trajectory data set.

The operations 212 may be looped, starting from the first bubble, for the t-th bubble until the trajectory ends by model simulation 202.

FIG. 2C illustrates exemplary operations 222 of a bubble feature generator model T_{bubble} (or referred to as a feature generator model for short), in accordance with various embodiments. The operations may generate a plurality of the next (t+1)^{th} bubbling features xₜ₊₁˜T_{bubble}(xₜ₊₁|xₜ, cₜ, aₜ) according to the bubble feature generator model T_{bubble}. The operations 222 may be implemented in various environments including, for example, by the system 100 of FIG. 1A and FIG. 1B. The operations 222 may be implemented by one or more components of the system 102. For example, a non-transitory computer-readable storage medium (e.g., the memory 106) may store instructions that, when executed by a processor (e.g., the processor 104), cause the system 102 (e.g., the processor 104) to perform the operations 222. The operations 222 presented below are intended to be illustrative. The operations shown in FIG. 2C and presented below are intended to be illustrative. Depending on the implementation, the operations 222 may include additional, fewer, or alternative steps performed in various orders or in parallel.

In some embodiments, step 223 includes obtaining a plurality of bubbling features of a t-th bubble xₜ. For example, for the first bubble, step 223 includes obtaining a plurality of bubbling features of a first bubble x₁ of a first transportation plan bubbling on a first day within the consecutive period of time.

In some embodiments, step 224 includes obtaining a t-th discount vector cₜ according to a subsidy policy model. For example, for the first bubble, step 224 includes obtaining the first discount vector c₁ according to the subsidy policy model.

In some embodiments, step 225 includes obtaining the t-th number of gap days aₜ. For example, for the first bubble, step 225 includes obtaining the first number of gap days a₁ generated by the operations 212.

In some embodiments, step 226 includes encoding the bubbling features of the t-th bubble, the t-th discount vector, and the number of gap days for the t-th bubble to a different hidden variable space z_{T}. For example, for the first bubble, step 226 includes encoding the first number of gap days a₁, the plurality of bubbling features of the first bubble x₁, and the first discount vector c₁ to a different hidden variable space zₜ₁.

In some embodiments, step 227 includes obtaining a t-th discount vector cₜ according to a subsidy policy model. For example, for the first bubble, step 227 includes obtaining the first discount vector c₁ according to the subsidy policy model.

In some embodiments, step 228 includes obtaining the t-th number of gap days aₜ. For example, for the first bubble, step 228 includes obtaining the first number of gap days a₁.

In some embodiments, step 229 includes decoding the different hidden variable space, the first discount vector c₁, and the first number of gap days a₁ to output a plurality of bubbling features of a next bubble xₜ₊₁. For example, for the first bubble, step 229 includes decoding the different hidden variable space zₜ₁, the first discount vector c₁, and the first number of gap days a₁ to output a plurality of bubbling features of a second bubble x₂. The day feature d₂ in the plurality of bubbling features of the second bubblex₂ is updated as d₂=d₁+a₁.

In some embodiments, step 230 includes outputting the plurality of bubbling features of the next bubble xₜ₊₁. For example, for the first bubble, step 230 includes outputting the plurality of bubbling features of the second bubble x₂, and stores it in the trajectory data set.

The operations 222 may be looped, starting from the first bubble, for the t-th bubble until the trajectory ends by model simulation 202.

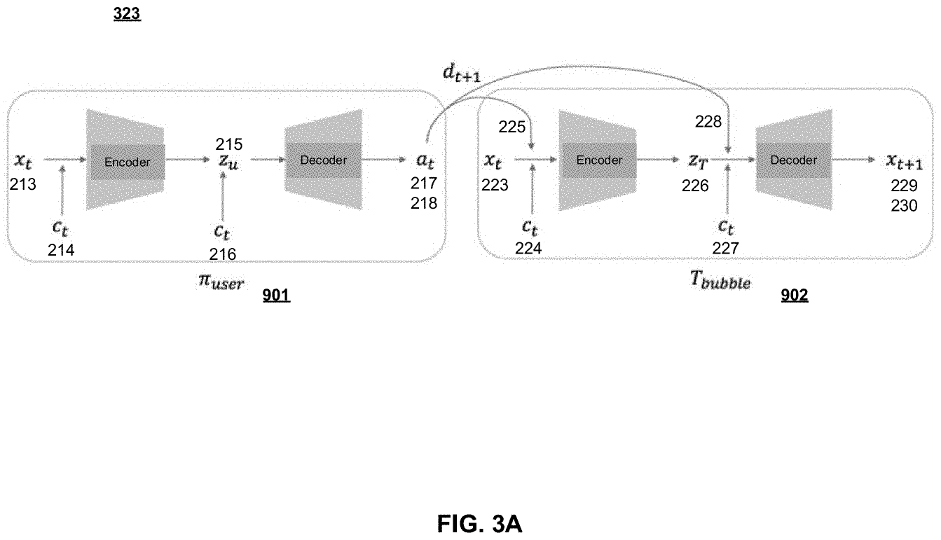

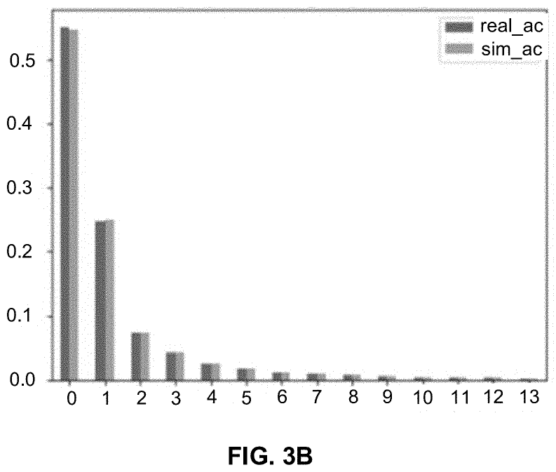

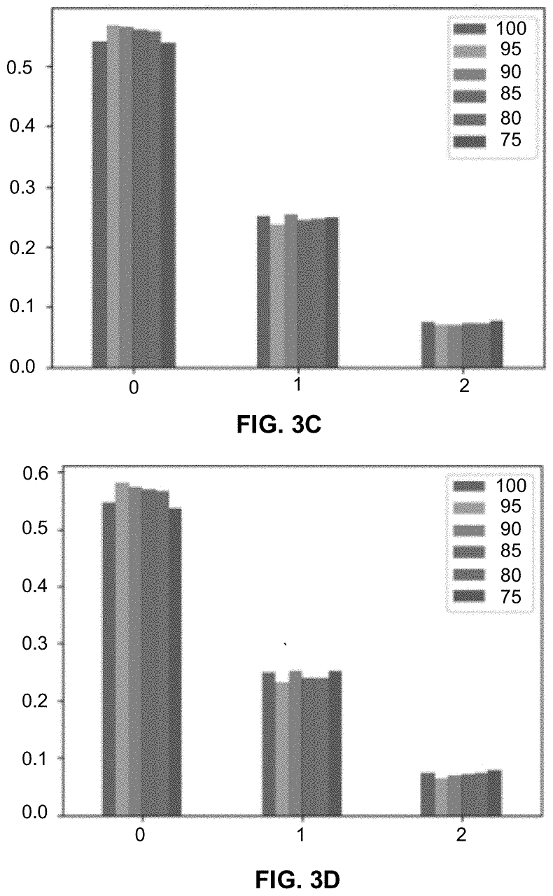

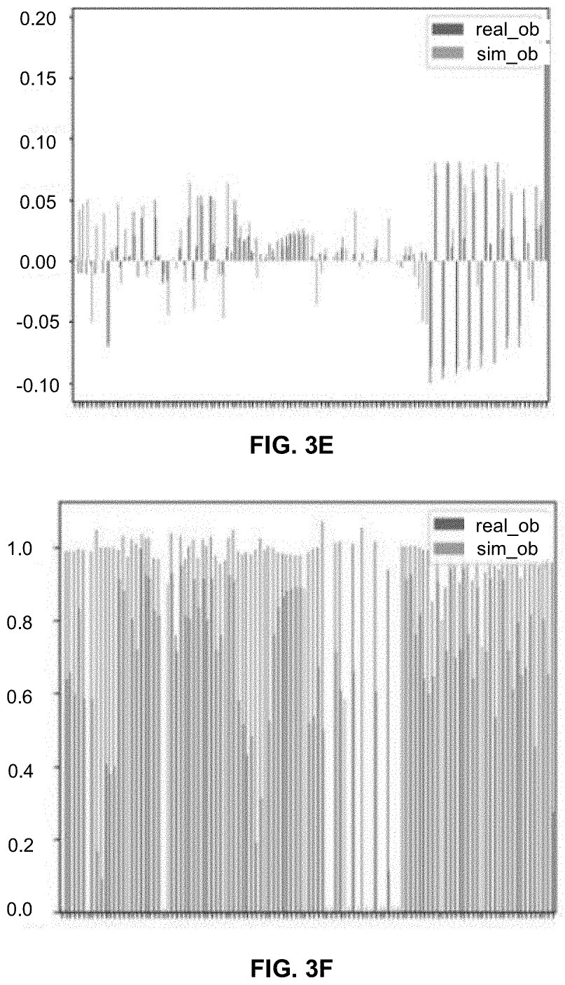

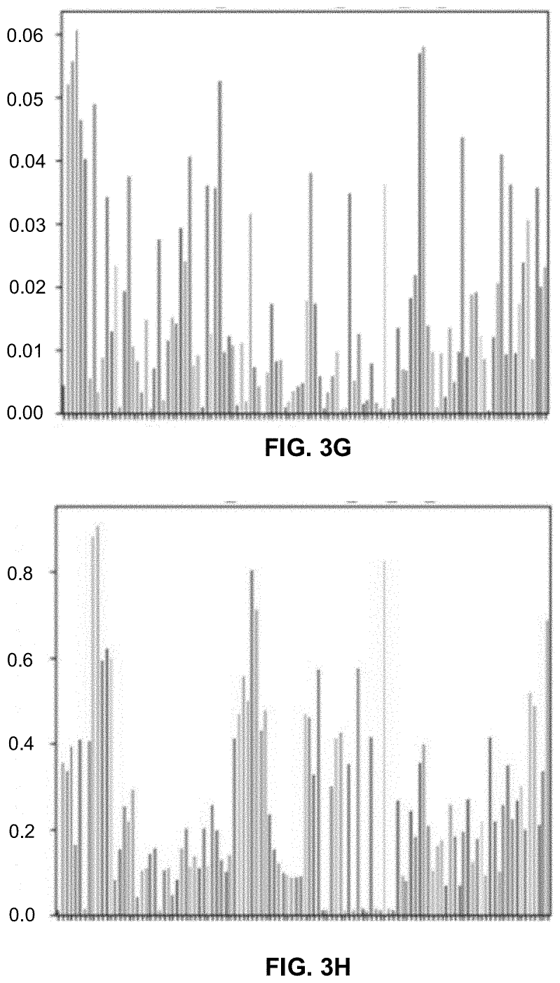

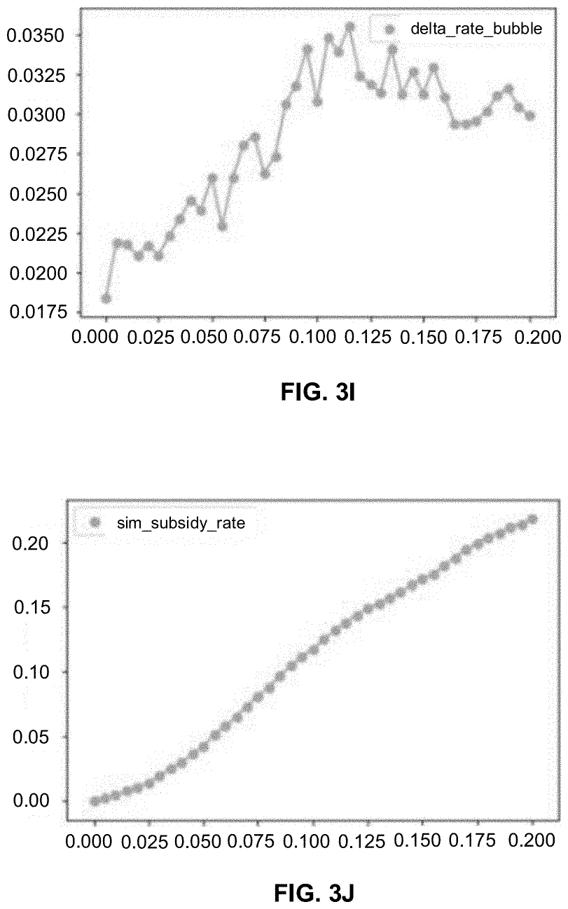

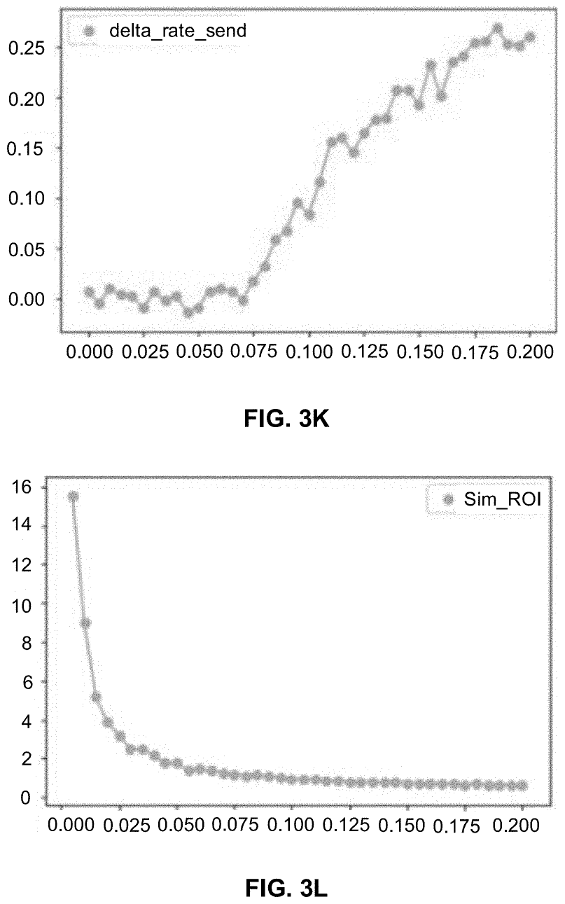

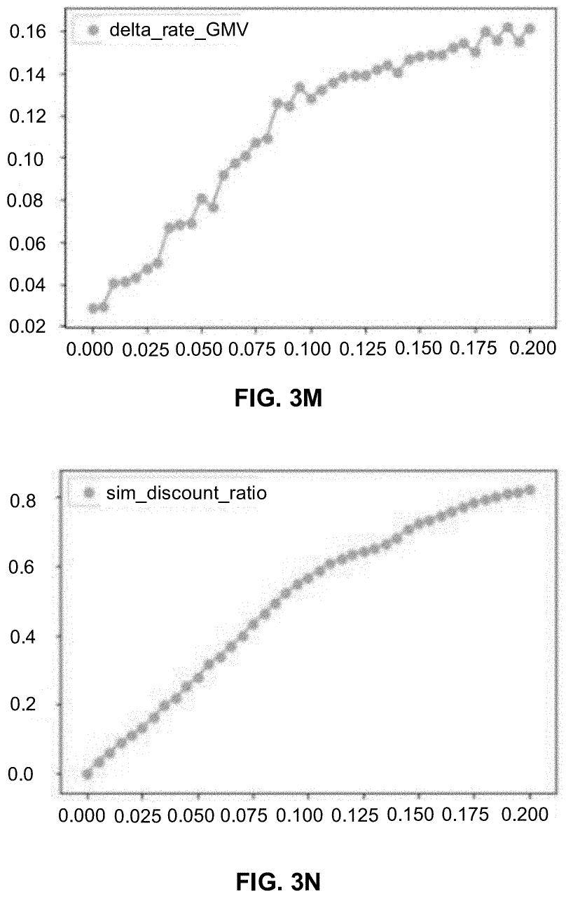

FIG. 3A illustrates an exemplary simulator 323 for simulating transportation order bubbling, in accordance with various embodiments. The simulator 323 may be implemented in various environments including, for example, by the system 100 of FIG. 1A and FIG. 1B. The simulator 323 may be implemented by one or more components of the system 102. For example, a non-transitory computer-readable storage medium (e.g., the memory 106) may store instructions that, when executed by a processor (e.g., the processor 104), cause the system 102 (e.g., the processor 104) to perform the operations. The operations presented below are intended to be illustrative. The operations shown in FIG. 3A and presented below are intended to be illustrative. Depending on the implementation, the operations may include additional, fewer, or alternative steps performed in various orders or in parallel.

In some embodiments, the simulator 323 may include the passenger behavior policy model πᵤₛₑᵣ 901 and the bubble feature generator model T_{bubble} 902, which may be combined for model training and simulation. Various operations 213-218 with respect to the passenger behavior policy model πᵤₛₑᵣ may be referred to FIG. 2B described above, and operations 223-230 with respect to the bubble feature generator model T_{bubble} 902 may be referred to FIG. 2C described above. In some embodiments, by the operations of the simulator 323, a data set is generated by simulation. The data set includes, for various steps t, the plurality of bubbling features of a t-th bubble xₜ, the discount vector cₜ, the number of gap days aₜ, and the plurality of bubbling features of the next (t+1)^{th} bubble xₜ₊₁. The data set may include quaternion data like {(xₜ, cₜ, aₜ, xₜ₊₁)}. The first discount vector c₁ may include a p dimensional vector, where p may be 1, 2, 3, etc. For example, if p is six, the six dimensional vector may corresponds to six different discounts.

In some embodiments, both the passenger behavior policy model πᵤₛₑᵣ 901 and the bubble feature generator model T_{bubble} 902 use the conditional VAE (CVAE) framework. For example, the CVAE is a conditional directed graphical model whose input observations modulate the prior on Gaussian latent variables that generate the outputs. CVAE models latent variables and data, both conditioned to some random variables, so that the conditional marginal log-likelihood is maximized.

In some embodiments, the quaternion data set {(xₜ, cₜ, aₜ, xₜ₊₁)} for the passenger behavior policy model πᵤₛₑᵣ 901 is optimized though an encoding and decoding process. Through the process, the log likelihood of data P(aₜ|zᵤ, cₜ) is optimized under some “encoding” error. Through the encoder module Q(z|xₜ, cₜ), the input information xₜ and the condition cₜ are compressed and mapped to a low dimensional hidden variable space zᵤ. Then, in order to achieve end-to-end distribution learning, the decoder module P(·|z, cₜ) decodes the hidden variable information z until it gets a distribution within a threshold error to the distribution of real output variables. The loss function of the passenger behavior policy model πᵤₛₑᵣ 901 during training is shown in Equation (1):

L_{π}_{ᵤₛₑᵣ}=−E[log P(aₜ|zᵤ,cₜ)]+D_{KL}[Q(zᵤ|xₜ,cₜ)∥N(0,1)] (1)

In some embodiments, the quaternion data set {(xₜ, cₜ, aₜ, xₜ₊₁)} for the bubble feature generator model T_{bubble} 902 is optimized though an encoding and decoding process. Through the process, the log likelihood of data P(aₜ|zₜ, cₜ) is optimized under some “encoding” error. Through the encoder module Q(z|xₜ, cₜ), the input information xₜ and the condition cₜ are compressed and mapped to a low dimensional hidden variable space zₜ. Then, in order to achieve end-to-end distribution learning, the decoder module P(·|z, cₜ) decodes the hidden variable information z until it gets a distribution within a threshold error to the distribution of real output variables. The loss function of the bubble feature generator model T_{bubble} 902 during training is shown in Equation (2):

L_{T}_{_{bubble}}=−E[log P(xₜ₊₁|zᵤ,cₜ)]+D_{KL}[Q(zᵤ|xₜ,cₜ)∥N(0,1)] (2)

In some embodiments, after the passenger behavior policy model πᵤₛₑᵣ 901 and the bubble feature generator model T_{bubble} 902 are trained through the above stated supervised learning, passenger bubble trajectory generation 204 may generate passenger bubble trajectory for a given candidate discount strategy according to the simulation process in model simulation 202.

The effectiveness of the passenger behavior policy model πᵤₛₑᵣ 901 and the bubble feature generator model T_{bubble} 902 is verified in two aspects: (i) the fitting effect of CVAE model, as illustrated in FIG. 3B to 3H, and (ii) the reasonability of policy evaluation results of the trained models, as illustrated in FIG. 3I to 3N.

FIG. 3B illustrates a comparison between the output distribution of the passenger behavior policy model πᵤₛₑᵣ and the distribution of real data, in accordance with various embodiments. The horizontal axis reflects the number of interval days between two adjacent bubbles. The vertical axis reflects the corresponding distribution ratio of each number of interval days between two adjacent bubbles. The legend real_ac represents real data collected for a consecutive period of time. The legend sim_ac represents simulated data for the same consecutive period of time, for which only data for the first day is real data. The comparison shows that the simulation has a high degree of accuracy since the simulated data closely resembles the real data.

FIGS. 3C and 3D respectively illustrate the simulated and real distributions of passenger interval days of two adjacent bubbles under six different discounts, in accordance with various embodiments. The horizontal axis reflects the number of interval days between two adjacent bubbles. Here, only the distributions for 0, 1, and 2 interval days are shown. The vertical axis reflects the distribution proportion of the corresponding distribution ratio of each number of interval days between two adjacent bubbles. The legend 100 represents no discount. The legend 95 represents a 5% discount. The legend 90 represents a 10% discount. The legend 85 represents a 15% discount. The legend 80 represents a 20% discount. The legend 75 represents a 25% discount. For frequent users of the ride-hailing platform (e.g., 0 interval days between two adjacent bubbles), both the simulated and real data shows that 5% and 10% discounts generate the most bubbling on the same day. For occasional users of the ride-hailing platform (e.g., 2 interval days between two adjacent bubbles), both the simulated and real data shows that a 25% discount generates the most bubbling on the second interval day. The comparison shows that the simulation has a high degree of accuracy since the simulated data closely resembles the real data.

FIG. 3E illustrates a comparison of the transition distribution mean of each feature dimension between the simulated data from the bubble feature generator model T_{bubble} and the real-world test data, in accordance with various embodiments. The horizontal axis represents features per dimension. The vertical axis represents the transition distribution mean. As shown in FIG. 3E, the transition distribution mean of most simulated and real feature dimension is within 0.10 and −0.10, and thus the model fits the state transition distribution well.

FIG. 3F illustrates a comparison of the transition distribution standard deviation of each feature dimension between the simulated data from the bubble feature generator model T_{bubble} and the real-world test data, in accordance with various embodiments. The horizontal axis represents features per dimension. The vertical axis represents the standard deviation. As shown in FIG. 3G, the transition distribution standard deviation of most simulated and real feature dimension is within 1.0, and thus the model fits the state transition distribution well.

FIG. 3G illustrates a comparison of the mean absolute percentage error (MAPE) between the simulated data from the bubble feature generator model T_{bubble} and the real-world test data, in accordance with various embodiments. The horizontal axis represents features per dimension. The vertical axis represents the mean error. For example, the MAPE is a measure of prediction accuracy of a forecasting method in statistics (e.g., trend estimation, loss function for regression problems). The MAPE expresses the accuracy of the trained model as a ratio. As shown in FIG. 3G, the simulation error of the distribution mean of most features is less than 0.04, and thus the model fits the state transition distribution well.

FIG. 3H illustrates a comparison of the transition distribution standard distribution error between the simulated data from the bubble feature generator model T_{bubble} and the real-world test data, in accordance with various embodiments. The horizontal axis represents features per dimension. The vertical axis represents the standard deviation error. As shown in FIG. 3H, the simulation error of the distribution standard deviation of most features is less than 0.4, and thus the model fits the state transition distribution well.

In some embodiments, an existing subsidy policy may be used to interact with the exemplary method 200 to simulate transportation order bubbling and to obtain various metrics. In some embodiments, a total of 40 subsidy policies with different discount rates ranging from 0 to 20% are prepared. Each subsidy policy is then used to interact with the exemplary method 200 to obtain the following metrics: an average passenger bubble frequency, a total GMV of issued orders, a total cost, and a total amount of issued orders. Next, through a simulation of the A/B test (e.g. a randomized experiment with two variants, A and B, with A being the control group, and B being the strategy group), the simulated subsidy rate (defined as the total cost divided by the total GMV of issued orders) and ROI for each strategy (defined as the difference of GMV between the control group and the strategy group divided by the difference of costs between the control group and the strategy group) are obtained. Through these different metrics, performances of different subsidy policies may be compared and accessed.

FIG. 3I illustrates the trending of the passengers' average bubble frequency increasing rate with respect to the preset discount rate, in accordance with various embodiments. The horizontal axis represents the preset discount rate of the subsidy policy. The vertical axis represents the value of the passengers' average bubble frequency increasing rate. As shown in FIG. 3I, as the preset discount rate increases from 0.000 to 0.100, the passengers' average bubble frequency increasing rate trends upward. As the preset discount rate continuously increases from 0.100 to 0.200, the passengers' average bubble frequency increasing rate remains relatively steady. The data supports general principles because after the preset discount rate reaches a bottleneck at 0.100, the passengers' average bubble frequency increasing rate would not increase as rapidly. Thus, FIG. 3I shows the effectiveness and reasonability of the disclosed methods.

FIG. 3J illustrates the trending of the simulated discount rate with respect to the preset discount rate, in accordance with various embodiments. The horizontal axis represents the preset discount rate of the subsidy policy. The vertical axis represents simulated discount rates. As shown in FIG. 3J, the simulated discount rate is consistent with the preset discount rate. Thus, FIG. 3J shows the effectiveness and reasonability of the disclosed methods.

FIG. 3K illustrates the trending of the passengers' order number increasing rate with respect to the preset discount rate, in accordance with various embodiments. The horizontal axis represents the preset discount rate of the subsidy policy. The vertical axis represents the passengers' order number increasing rate. As shown in FIG. 3K, as the preset discount rate increases, the passengers' order number increasing rate increases accordingly. Thus, FIG. 3K shows the effectiveness and reasonability of the disclosed methods.

FIG. 3L illustrates the trending of the simulated ROI with respect to the preset discount rate, in accordance with various embodiments. The horizontal axis represents the preset discount rate of the subsidy policy. The vertical axis represents the simulated ROI. As shown in FIG. 3L, the simulated ROI shows a trend of decreasing with the increase of the preset discount rate. Thus, FIG. 3L shows the effectiveness and reasonability of the disclosed methods.

FIG. 3M illustrates the trending of GMV increasing rate with respect to the preset discount rate, in accordance with various embodiments. The horizontal axis represents the preset discount rate of the subsidy policy. The vertical axis represents the GMV increasing rate. As shown in FIG. 3M, as the preset discount rate increases, the GMV increase rate increases accordingly. Thus, FIG. 3M shows the effectiveness and reasonability of the disclosed methods.

FIG. 3N illustrates the trending of the simulated discount bubble proportion with respect to the preset discount rate, in accordance with various embodiments. The horizontal axis represents the preset discount rate of the subsidy policy. The vertical axis represents the simulated discount bubble proportion. As shown in FIG. 3N, as the preset discount rate increases, the simulated discount bubble proportion increases accordingly. Thus, FIG. 3N shows the effectiveness and reasonability of the disclosed methods.

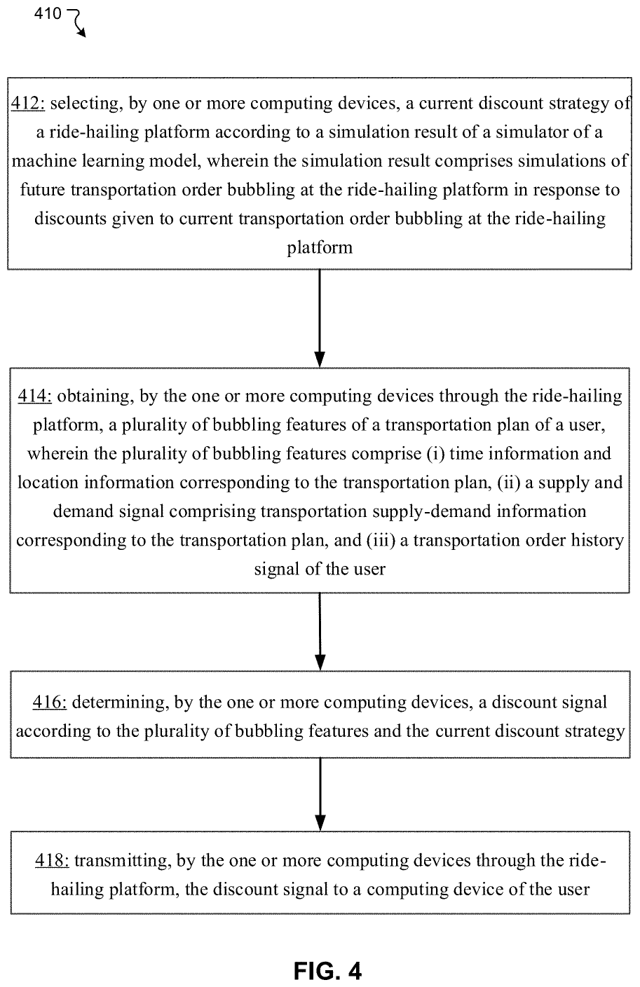

FIG. 4 illustrates a flowchart of an exemplary method 410 for simulating transportation order bubbling, according to various embodiments of the present disclosure. The method 410 may be implemented in various environments including, for example, by the system 100 of FIG. 1A and FIG. 1B. The exemplary method 410 may be implemented by one or more components of the system 102. For example, a non-transitory computer-readable storage medium (e.g., the memory 106) may store instructions that, when executed by a processor (e.g., the processor 104), cause the system 102 (e.g., the processor 104) to perform the method 410. The operations of method 410 presented below are intended to be illustrative. Depending on the implementation, the exemplary method 410 may include additional, fewer, or alternative steps performed in various orders or in parallel.

Block 412 includes selecting, by one or more computing devices, a current discount strategy of a ride-hailing platform according to a simulation result of a simulator of a machine learning model, wherein the simulation result comprises simulations of future transportation order bubbling at the ride-hailing platform in response to discounts given to current transportation order bubbling at the ride-hailing platform. The simulator may be referred to FIGS. 2A-3A above.

The simulator may be configured to simulate user bubbling at the ride-hailing platform under each of a plurality of candidate discount strategies, and select a current discount strategy from them. Each discount strategy may comprise rules for offering discounts based on one or more bubbling features. In some embodiments, selecting the current discount strategy according to the simulation result of the simulator of the machine learning model comprises: collecting recent transportation order bubbling data, wherein the recent transportation order bubbling data comprises a plurality of bubbling features of a plurality of transportation plans of a plurality of users; respectively evaluating a plurality of candidate discount strategies by setting a target evaluation time period, feeding each strategy-data pair to the simulator to simulate transportation order bubbling within the target evaluation time period under influence of one or more previous discounts, and obtaining from the simulator a total revenue income to the ride-hailing platform within the target evaluation time period under each of the plurality of candidate discount strategies, wherein the strategy-data pair comprises one of the plurality of candidate discount strategies and the recent transportation order bubbling data; and selecting the current discount strategy from the plurality of candidate discount strategies by maximizing the total revenue income to the ride-hailing platform within the target evaluation time period.

In some embodiments, each of the plurality of candidate discount strategies comprises a plurality of discount policies each corresponding to a discount rate. The benefit of selecting a plurality of discount policies each corresponding to a discount rate is that the ride-hailing platform may evaluate multiple discount rates at the same time and select the discount rate that would maximize the total revenue income to the ride-hailing platform.

In some embodiments, a target evaluation time period may be any consecutive period that the ride-hailing platform selects to evaluate its discount strategies.

In some embodiments, the simulator is configured to iteratively performing the following steps until a consecutive period of time (e.g., two weeks, one month, etc.) ends: in a current iteration, receiving a first input comprising a first plurality of bubbling features of a first bubble (x₁) of a first transportation plan bubbling on a first day within the consecutive period of time; determining, based on the first input and a candidate discount strategy, a first discount vector (c₁); generating, based on the first input, a second plurality of bubbling features of a second bubble (x₂) of a second transportation plan bubbling on a second day within the consecutive period of time; and generating, based on the first input and the first discount vector (c₁), a first number of gap days (a₁) between the first and the second days, wherein a first output of the simulator comprises the second plurality of bubbling features of the second bubble (x₂) and the first number of gap days (a₁), and the first output is a second input of the simulator in a next iteration.

In some embodiments, the method further comprises: based on historical ride-hailing data, generating, by the one or more computing devices, simulation data comprising a t^{th} plurality of bubbling features of a t^{th} bubble (xₜ) of a t^{th} transportation plan of a test user bubbling on a day within a consecutive period of time, a t^{th} discount vector (cₜ) provided to the t^{th} transportation plan, a t^{th} number of gap days (aₜ) from the day until a (t+1)^{th} transportation plan of the test user bubbling on a different day within the consecutive period of time, and a (t+1)^{th} plurality of bubbling features of a (t+1)^{th} bubble (xₜ+₁) of a (t+1)^{th} transportation plan bubbling on the different day within the consecutive period of time, wherein t is a natural number; and training, by the one or more computing devices, the machine learning model by minimizing a difference between the simulation data and the historical ride-hailing data.

In some embodiments, the simulator comprises a passenger behavior policy model (πᵤₛₑᵣ) and a feature generator model (T_{bubble}); the simulator is configured to generate the t^{th} number of gap days (aₜ) by feeding the t^{th} plurality of bubbling features of the t^{th} bubble (xₜ) and the t^{th} discount vector (cₜ) to the passenger behavior policy model (πᵤₛₑᵣ); and the simulator is configured to generate the (t+1)^{th} plurality of bubbling features of the (t+1)^{th} bubble (xₜ₊₁) by feeding the t^{th} plurality of bubbling features of the t^{th} bubble (xₜ), the t^{th} discount vector (cₜ), and the t^{th} number of gap days (aₜ) to the feature generator model (T_{bubble}).

In some embodiments, the passenger behavior policy model (πᵤₛₑᵣ) comprises a first encoder and a first decoder; the feature generator model (T_{bubble}) comprises a second encoder and a second decoder; the first encoder is configured to compress the t^{th} plurality of bubbling features of the t^{th} bubble (xₜ) and the t^{th} discount vector (cₜ) and map the t^{th} plurality of bubbling features of the t^{th} bubble (xₜ) and the t^{th} discount vector (cₜ) to a hidden variable space (zᵤ); the first decoder is configured to receive the hidden variable space (zᵤ) and the t^{th} discount vector (cₜ) and decode the hidden variable space (zᵤ) to output the t^{th} number of gap days (aₜ); the second encoder is configured to compress the t^{th} plurality of bubbling features of the t^{th} bubble (xₜ), the t^{th} discount vector (cₜ), and the t^{th} number of gap days (aₜ) and map the t^{th} plurality of bubbling features of the t^{th} bubble (xₜ), the t^{th} discount vector (cₜ), and the t^{th} number of gap days (aₜ) to a different hidden variable space (zₜ); and the second decoder is configured to receive the different hidden variable space (zₜ), the t^{th} discount vector (cₜ), and the t^{th} number of gap days (aₜ) and decode the different hidden variable space (zₜ) to output the (t+1)*^{h} plurality of bubbling features of the (t+1)^{th} bubble (xₜ₊₁).

In some embodiments, training the machine learning model comprises: training the passenger behavior policy model (πᵤₛₑᵣ) and the feature generator model (T_{bubble}) respectively based on a conditional variational autoencoder (CVAE) algorithm.

Block 414 includes obtaining, by the one or more computing devices through the ride-hailing platform, a plurality of bubbling features of a transportation plan of a user, wherein the plurality of bubbling features comprise (i) a bubble signal comprising time information and location information (e.g., time information corresponding a bubbling, location information corresponding to the bubbling) corresponding to the transportation plan, (ii) a supply and demand signal comprising transportation supply-demand information corresponding to the transportation plan (e.g., supply information corresponding a bubbling and/or demand information corresponding to the bubbling), and (iii) a transportation order history signal of the user (e.g., transportation order completion history). The route may include a total distance of the route. The route, the travel duration, and the price quote may each be determined (i) at the platform or (ii) at the user device and sent to the platform. The origin location may comprise a GPS signal transmitted from the user device to the platform (e.g., the system 102).

In some embodiments, the location information comprises an origin location of the transportation plan of the user, a destination location of the transportation plan, a route departing from the origin location and arriving at the destination location; the time information comprises a timestamp, and a vehicle travel duration along the route; the bubble signal further comprises a price quote corresponding to the transportation plan; and the transportation supply-demand information comprises a number of passenger-seeking vehicles around the origin location, and a number of vehicle-seeking transportation orders departing from the origin location.

In some embodiments, the origin location of the transportation plan of the user comprises a geographical positioning signal of the computing device of the user; and obtaining the supply and demand signal comprises: for a supply signal, obtaining, from a plurality of computing devices of a plurality of vehicle drivers, a plurality of geographical positioning signals respectively corresponding to the plurality of computing devices of the plurality vehicle drivers; and determining the number of passenger-seeking vehicles around the origin based on the plurality of geographical positioning signals and the geographical positioning signal of the computing device of the user. In some embodiments, obtaining the supply and demand signal comprises: for a demand signal, obtaining, from a plurality of computing devices of a plurality of users, a plurality of geographical positioning signals respectively corresponding to the plurality of users; and determining the number of ride-seeking users around a vehicle based on the plurality of geographical positioning signals respectively corresponding to the plurality of users and a geographical positioning signal of the vehicle or of a computing device of a driver of the vehicle. In some embodiments, the geographical positioning signal comprises a Global Positioning System (GPS) signal; and the plurality of geographical positioning signals comprise a plurality of GPS signals.

In some embodiments, obtaining the route departing from the origin location and arriving at the destination location comprises: obtaining, from the geographical positioning signals of the original location and destination of the user, a plurality of routes based on the geographical positioning signals of the original location and destination of the user through a mapping system; and determining, a route that connects the geographical positions of the original location and destination of the user.

In some embodiments, obtaining the vehicle travel duration along the route comprises: obtaining, from a plurality of computing devices of a plurality of vehicle drivers, a plurality of geographical positioning signals respectively corresponding to the plurality of computing devices of the plurality vehicle drivers traveling on or near the determined route; determining a plurality of speed of the plurality vehicle drivers based on the plurality of change in geographical positioning signals during an interval period of time; and determining, based on the plurality of speed of the plurality vehicle drivers traveling on or near the determined route, an estimated travel duration along the route.

In some embodiments, determining the vehicle travel distance along the route comprises: determining, from geographical positioning signals of the determined route, the distance of the determined route.

In some embodiments, the price quote of the corresponding travel plan comprises: determining, based on the vehicle travel duration along the route and the vehicle travel distance along the route, an estimated price of the user's trip.

In some embodiments, the transportation order history signal of the user comprises one or more of the following: a frequency of order transportation order bubbling by the user (e.g., five times within the consecutive period of time); a frequency of transportation order completion by the user; a history of discount offers provided to the user in response to the order transportation order bubbling; and a history of responses of the user to the discount offers.

Block 416 includes determining, by the one or more computing devices, a discount signal according to the plurality of bubbling features and the current discount strategy. For example, according to the plurality of bubbling features, the current discount strategy may apply its rules to determine what kind of discount should be offered.

Block 418 includes transmitting, by the one or more computing devices through the ride-hailing platform, the discount signal to a computing device of the user.

In some embodiments, the method 410 further comprises presenting, by the computing device of the user, the discount signal (e.g., 20% off), the route, and the price quote.

In some embodiments, the method 410 further comprises receiving, by the one or more computing devices, from the computing device of the user, an acceptance signal comprising an acceptance of the transportation plan of the user, the price quote, and a price discount corresponding to the discount signal; and transmitting, by the one or more computing devices, the transportation plan to a computing device of a vehicle driver for fulfilling the transportation order. For example, after the bubbling, the user's device may receive a quote along with a discount. After the user accepts the offer, the user's device transmits the acceptance signal to the platform, and the platform may match the user with a vehicle.

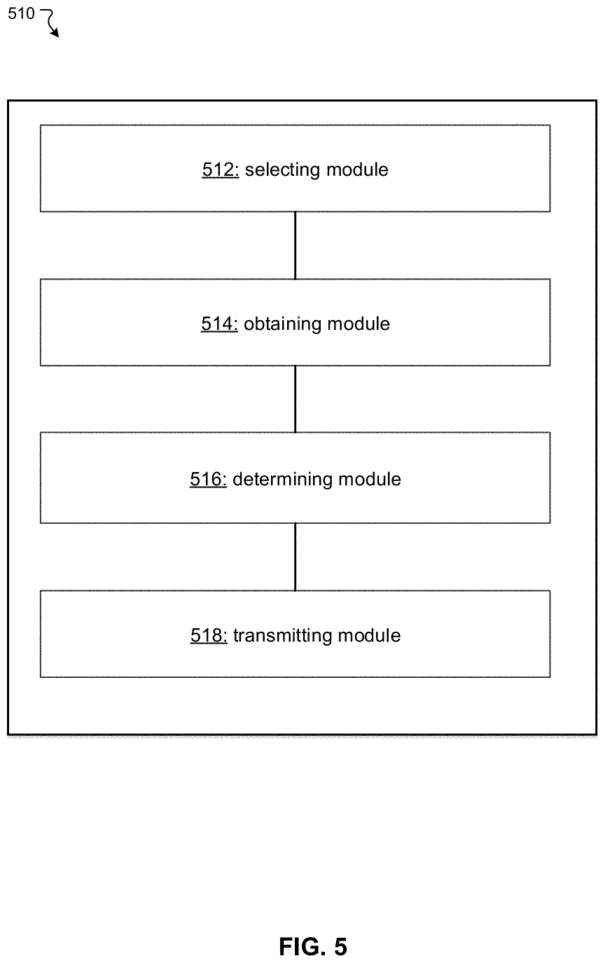

FIG. 5 illustrates a block diagram of an exemplary computer system 510 for simulating transportation order bubbling, in accordance with various embodiments. The system 510 may be an exemplary implementation of the system 102 of FIG. 1A and FIG. 1B or one or more similar devices. The method 410 may be implemented by the computer system 510. The computer system 510 may include one or more processors and one or more non-transitory computer-readable storage media (e.g., one or more memories) coupled to the one or more processors and configured with instructions executable by the one or more processors to cause the system or device (e.g., the processor) to perform the method 410. The computer system 510 may include various units/modules corresponding to the instructions (e.g., software instructions). In some embodiments, the instructions may correspond to a software such as a desktop software or an application (APP) installed on a mobile phone, pad, etc.

In some embodiments, the computer system 510 may include a selecting module 512 configured to select a current discount strategy of a ride-hailing platform according to a simulation result of a simulator of a machine learning model, wherein the simulation result comprises simulations of future transportation order bubbling at the ride-hailing platform in response to discounts given to current transportation order bubbling at the ride-hailing platform; an obtaining module 514 configured to obtain, through the ride-hailing platform, a plurality of bubbling features of a transportation plan of a user, wherein the plurality of bubbling features comprise (i) a bubble signal comprising a timestamp, an origin location of the transportation plan of the user, a destination location of the transportation plan, a route departing from the origin location and arriving at the destination location, a vehicle travel duration along the route, and a price quote corresponding to the transportation plan, (ii) a supply and demand signal comprising a number of passenger-seeking vehicles around the origin location, and a number of vehicle-seeking transportation orders departing from the origin location, and (iii) a transportation order history signal of the user; a determining module 516 configured to determine a discount signal according to the plurality of bubbling features and the current discount strategy; and a transmitting module 518 configured to transmit, through the ride-hailing platform, the discount signal to a computing device of the user.

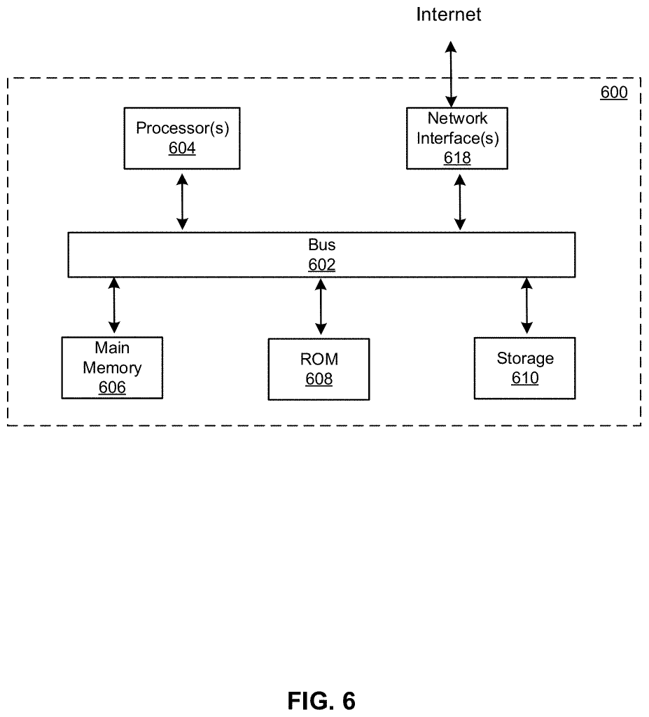

FIG. 6 is a block diagram that illustrates a computer system 600 upon which any of the embodiments described herein may be implemented. The system 600 may correspond to the system 102 or the computing device 109, 110, or 111 described above. The computer system 600 includes a bus 602 or another communication mechanism for communicating information, one or more hardware processors 604 coupled with bus 602 for processing information. Hardware processor(s) 604 may be, for example, one or more general-purpose microprocessors.

The computer system 600 also includes a main memory 606, such as a random access memory (RAM), cache, and/or other dynamic storage devices, coupled to bus 602 for storing information and instructions to be executed by processor 604. Main memory 606 also may be used for storing temporary variables or other intermediate information during execution of instructions to be executed by processor 604. Such instructions, when stored in storage media accessible to processor 604, render computer system 600 into a special-purpose machine that is customized to perform the operations specified in the instructions. The computer system 600 further includes a read-only memory (ROM) 608 or other static storage device coupled to bus 602 for storing static information and instructions for processor 604. A storage device 610, such as a magnetic disk, optical disk, or USB thumb drive (Flash drive), etc., is provided and coupled to bus 602 for storing information and instructions.

The computer system 600 may implement the techniques described herein using customized hard-wired logic, one or more ASICs or FPGAs, firmware, and/or program logic which in combination with the computer system causes or programs computer system 600 to be a special-purpose machine. According to one embodiment, the techniques herein are performed by computer system 600 in response to processor(s) 604 executing one or more sequences of one or more instructions contained in main memory 606. Such instructions may be read into main memory 606 from another storage medium, such as storage device 610. Execution of the sequences of instructions contained in main memory 606 causes processor(s) 604 to perform the process steps described herein. In alternative embodiments, hard-wired circuitry may be used in place of or in combination with software instructions.

The main memory 606, the ROM 608, and/or the storage 610 may include non-transitory storage media. The term “non-transitory media,” and similar terms, as used herein refers to a media that stores data and/or instructions that cause a machine to operate in a specific fashion. The media excludes transitory signals. Such non-transitory media may include non-volatile media and/or volatile media. Non-volatile media includes, for example, optical or magnetic disks, such as storage device 610. Volatile media includes dynamic memory, such as main memory 606. Common forms of non-transitory media may include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, an EPROM, a FLASH-EPROM, NVRAM, any other memory chip or cartridge, and networked versions of the same.

The computer system 600 also includes a network interface 618 coupled to bus 602. Network interface 618 provides a two-way data communication coupling to one or more network links that are connected to one or more local networks. For example, network interface 618 may be an integrated services digital network (ISDN) card, cable modem, satellite modem, or a modem to provide a data communication connection to a corresponding type of telephone line. As another example, network interface 618 may be a local area network (LAN) card to provide a data communication connection to a compatible LAN (or WAN component to communicated with a WAN). Wireless links may also be implemented. In any such implementation, network interface 618 sends and receives electrical, electromagnetic, or optical signals that carry digital data streams representing various types of information.

The computer system 600 can send messages and receive data, including program code, through the network(s), network link, and network interface 618. In the Internet example, a server might transmit a requested code for an application program through the Internet, the ISP, the local network, and the network interface 618.

The received code may be executed by processor 604 as it is received, and/or stored in storage device 610, or other non-volatile storage for later execution.

Each of the processes, methods, and algorithms described in the preceding sections may be embodied in, and fully or partially automated by, code modules executed by one or more computer systems or computer processors including computer hardware. The processes and algorithms may be implemented partially or wholly in application-specific circuitry.

The various features and processes described above may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The exemplary blocks or states may be performed in serial, in parallel, or in some other manner. Blocks or states may be added to or removed from the disclosed exemplary embodiments. The exemplary systems and components described herein may be configured differently than described. For example, elements may be added to, removed from, or rearranged compared to the disclosed exemplary embodiments.

The various operations of exemplary methods described herein may be performed, at least partially, by an algorithm. The algorithm may be included in program codes or instructions stored in a memory (e.g., a non-transitory computer-readable storage medium described above). Such algorithm may include a machine learning algorithm. In some embodiments, a machine learning algorithm may not explicitly program computers to perform a function, but can learn from training data to make a predictions model that performs the function.

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein.

Similarly, the methods described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS).

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

As used herein, the term “or” may be construed in either an inclusive or exclusive sense. Moreover, plural instances may be provided for resources, operations, or structures described herein as a single instance. Additionally, boundaries between various resources, operations, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the exemplary configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

Although an overview of the subject matter has been described with reference to specific exemplary embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

What is claimed is:

1. A computer-implemented method for simulating transportation order bubbling at a ride-hailing platform and applying the simulated transportation order bubbling, comprising:
selecting, by one or more computing devices, a current discount strategy according to a simulation result of a simulator of a machine learning model, wherein the simulation result comprises simulations of future transportation order bubbling in response to discounts given to current transportation order bubbling;
obtaining, by the one or more computing devices, a plurality of bubbling features of a transportation plan of a user, wherein the plurality of bubbling features comprise (i) a bubble signal comprising time information and location information corresponding to the transportation plan, (ii) a supply and demand signal comprising transportation supply-demand information corresponding to the transportation plan, and (iii) a transportation order history signal of the user;
determining, by the one or more computing devices, a discount signal according to the plurality of bubbling features and the current discount strategy; and
transmitting, by the one or more computing devices, the discount signal to a computing device of the user.

2. The method of claim 1, wherein:
the location information comprises an origin location of the transportation plan of the user, a destination location of the transportation plan, a route departing from the origin location and arriving at the destination location;
the time information comprises a timestamp, and a vehicle travel duration along the route;
the bubble signal further comprises a price quote corresponding to the transportation plan; and
the transportation supply-demand information comprises a number of passenger-seeking vehicles around the origin location, and a number of vehicle-seeking transportation orders departing from the origin location.

3. The method of claim 2, wherein:
the origin location of the transportation plan of the user comprises a geographical positioning signal of the computing device of the user; and
obtaining the supply and demand signal comprises:
obtaining, from a plurality of computing devices of a plurality of vehicle drivers, a plurality of geographical positioning signals respectively corresponding to the plurality of computing devices of the plurality vehicle drivers; and
determining the number of passenger-seeking vehicles around the origin based on the plurality of geographical positioning signals and the geographical positioning signal of the computing device of the user.

4. The method of claim 3, wherein:
the geographical positioning signal comprises a Global Positioning System (GPS) signal; and
the plurality of geographical positioning signals comprise a plurality of GPS signals.

5. The method of claim 2, further comprising:
presenting, by the computing device of the user, the discount signal, the route, and the price quote.

6. The method of claim 2, further comprising:
receiving, by the one or more computing devices, from the computing device of the user, an acceptance signal comprising an acceptance of the transportation plan of the user, the price quote, and a price discount corresponding to the discount signal; and
transmitting, by the one or more computing devices, the transportation plan to a computing device of a vehicle driver for fulfilling the transportation order.

7. The method of claim 1, wherein the transportation order history signal of the user comprises one or more of the following:
a frequency of order transportation order bubbling by the user;
a frequency of transportation order completion by the user;
a history of discount offers provided to the user in response to the order transportation order bubbling; and
a history of responses of the user to the discount offers.

8. The method of claim 1, wherein selecting the current discount strategy according to the simulation result of the simulator of the machine learning model comprises:
collecting recent transportation order bubbling data, wherein the recent transportation order bubbling data comprises a plurality of bubbling features of a plurality of transportation plans of a plurality of users;
respectively evaluating a plurality of candidate discount strategies by setting a target evaluation time period, feeding each strategy-data pair to the simulator to simulate transportation order bubbling within the target evaluation time period under influence of one or more previous discounts, and obtaining from the simulator a total revenue income to the ride-hailing platform within the target evaluation time period under each of the plurality of candidate discount strategies, wherein the strategy-data pair comprises one of the plurality of candidate discount strategies and the recent transportation order bubbling data; and
selecting the current discount strategy from the plurality of candidate discount strategies by maximizing the total revenue income to the ride-hailing platform within the target evaluation time period.

9. The method of claim 1, further comprising iteratively performing the following steps until a consecutive period of time ends:
in a current iteration, receiving, by the simulator, a first input comprising a first plurality of bubbling features (x₁) of a first transportation plan bubbling on a first day within the consecutive period of time;
determining, by the simulator based on the first input and a candidate discount strategy, a first discount vector (c₁);
generating, by the simulator, based on the first input, a second plurality of bubbling features (x₂) of a second transportation plan bubbling on a second day within the consecutive period of time; and
generating, by the simulator, based on the first input and the first discount vector (c₁), a first number of gap days (a₁) between the first and the second days, wherein a first output of the simulator comprises the second plurality of bubbling features (x₂) and the first number of gap days (a₁), and the first output is a second input of the simulator in a next iteration.

10. The method of claim 1, further comprising:
based on historical ride-hailing data, generating, by the one or more computing devices, simulation data comprising a t^{th} plurality of bubbling features (xₜ) of a t^{th} transportation plan of a test user bubbling on a day within a consecutive period of time, a t^{th} discount vector (cₜ) provided to the t^{th} transportation plan, a t^{th} number of gap days (aₜ) from the day until a (t+1)^{th} transportation plan of the test user bubbling on a different day within the consecutive period of time, and a (t+1)^{th} plurality of bubbling features (xₜ₊₁) of a (t+1)^{th} transportation plan bubbling on the different day within the consecutive period of time, wherein t is a natural number; and
training, by the one or more computing devices, the machine learning model by minimizing a difference between the simulation data and the historical ride-hailing data.

11. The method of claim 10, wherein:
the simulator comprises a passenger behavior policy model (πᵤₛₑᵣ) and a feature generator model (T_{bubble});
the simulator is configured to generate the t^{th} number of gap days (aₜ) by feeding the t^{th} plurality of bubbling features (xₜ) and the t^{th} discount vector (cₜ) to the passenger behavior policy model (πᵤₛₑᵣ); and
the simulator is configured to generate the (t+1)^{th} plurality of bubbling features (xₜ₊₁) by feeding the t^{th} plurality of bubbling features (xₜ), the t^{th} discount vector (cₜ), and the t^{th} number of gap days (aₜ) to the feature generator model (T_{bubble}).

12. The method of claim 11, wherein:
the passenger behavior policy model (πᵤₛₑᵣ) comprises a first encoder and a first decoder;
the feature generator model (T_{bubble}) comprises a second encoder and a second decoder;
the first encoder is configured to compress the t^{th} plurality of bubbling features (xₜ) and the t^{th} discount vector (cₜ) and map the t^{th} plurality of bubbling features (xₜ) and the t^{th} discount vector (cₜ) to a hidden variable space (zᵤ);
the first decoder is configured to receive the hidden variable space (zᵤ) and the t^{th} discount vector (cₜ) and decode the hidden variable space (zᵤ) to output the t^{th} number of gap days (aₜ);
the second encoder is configured to compress the t^{th} plurality of bubbling features (xₜ), the t^{th} discount vector (cₜ), and the t^{th} number of gap days (aₜ) and map the t^{th} plurality of bubbling features (xₜ), the t^{th} discount vector (cₜ), and the t^{th} number of gap days (aₜ) to a different hidden variable space (zₜ); and
the second decoder is configured to receive the different hidden variable space (zₜ), the t^{th} discount vector (cₜ), and the t^{th} number of gap days (aₜ) and decode the different hidden variable space (zₜ) to output the (t+1)^{th} plurality of bubbling features (xₜ₊₁).

13. The method of claim 11, wherein training the machine learning model comprises:
training the feature generator model (T_{bubble}) and the passenger behavior policy model (πᵤₛₑᵣ) respectively based on a conditional variational autoencoder (CVAE) algorithm.

14. One or more non-transitory computer-readable storage media storing instructions executable by one or more processors, wherein execution of the instructions causes the one or more processors to perform operations comprising:
selecting a current discount strategy according to a simulation result of a simulator of a machine learning model, wherein the simulation result comprises simulations of future transportation order bubbling in response to discounts given to current transportation order bubbling at the ride-hailing platform;
obtaining a plurality of bubbling features of a transportation plan of a user, wherein the plurality of bubbling features comprise (i) a bubble signal comprising time information and location information corresponding to the transportation plan, (ii) a supply and demand signal comprising transportation supply-demand information corresponding to the transportation plan, and (iii) a transportation order history signal of the user;
determining a discount signal according to the plurality of bubbling features and the current discount strategy; and
transmitting the discount signal to a computing device of the user.

15. The one or more non-transitory computer-readable storage media of claim 14, wherein:
the origin location of the transportation plan of the user comprises a geographical positioning signal of the computing device of the user; and
obtaining the supply and demand signal comprises:
obtaining, from a plurality of computing devices of a plurality of vehicle drivers, a plurality of geographical positioning signals respectively corresponding to the plurality of computing devices of the plurality vehicle drivers; and
determining the number of passenger-seeking vehicles around the origin based on the plurality of geographical positioning signals and the geographical positioning signal of the computing device of the user.

16. The one or more non-transitory computer-readable storage media of claim 15, wherein:
the geographical positioning signal comprises a Global Positioning System (GPS) signal; and
the plurality of geographical positioning signals comprise a plurality of GPS signals.

17. The one or more non-transitory computer-readable storage media of claim 14, wherein selecting the current discount strategy according to the simulation result of the simulator of the machine learning model comprises:
collecting recent transportation order bubbling data, wherein the recent transportation order bubbling data comprises a plurality of bubbling features of a plurality of transportation plans of a plurality of users;
respectively evaluating a plurality of candidate discount strategies by setting a target evaluation time period, feeding each strategy-data pair to the simulator to simulate transportation order bubbling within the target evaluation time period under influence of one or more previous discounts, and obtaining from the simulator a total revenue income to a ride-hailing platform within the target evaluation time period under each of the plurality of candidate discount strategies, wherein the strategy-data pair comprises one of the plurality of candidate discount strategies and the recent transportation order bubbling data; and
selecting the current discount strategy from the plurality of candidate discount strategies by maximizing the total revenue income to the ride-hailing platform within the target evaluation time period.

18. The one or more non-transitory computer-readable storage media of claim 14, wherein the operations further comprise iteratively performing the following steps until a consecutive period of time ends:
in a current iteration, receiving a first input comprising a first plurality of bubbling features (x₁) of a first transportation plan bubbling on a first day within the consecutive period of time;
determining, based on the first input and a candidate discount strategy, a first discount vector (c₁);
generating, based on the first input, a second plurality of bubbling features (x₂) of a second transportation plan bubbling on a second day within the consecutive period of time; and
generating, based on the first input and the first discount vector (c₁), a first number of gap days (a₁) between the first and the second days, wherein a first output of the simulator comprises the second plurality of bubbling features (x₂) and the first number of gap days (a₁), and the first output is a second input of the simulator in a next iteration.

19. The one or more non-transitory computer-readable storage media of claim 14, wherein the operations further comprise:
based on historical ride-hailing data, generating simulation data comprising a t^{th} plurality of bubbling features (xₜ) of a t^{th} transportation plan of a test user bubbling on a day within a consecutive period of time, a t^{th} discount vector (cₜ) provided to the t^{th} transportation plan, a t^{th} number of gap days (aₜ) from the day until a (t+1)^{th} transportation plan of the test user bubbling on a different day within the consecutive period of time, and a (t+1)^{th} plurality of bubbling features (xₜ₊₁) of a (t+1)^{th} transportation plan bubbling on the different day within the consecutive period of time, wherein t is a natural number; and
training the machine learning model by minimizing a difference between the simulation data and the historical ride-hailing data.

20. A system comprising one or more processors and one or more non-transitory computer-readable memories coupled to the one or more processors and configured with instructions executable by the one or more processors to cause the system to perform operations comprising:
selecting a current discount strategy according to a simulation result of a simulator of a machine learning model, wherein the simulation result comprises simulations of future transportation order bubbling in response to discounts given to current transportation order bubbling;
obtaining a plurality of bubbling features of a transportation plan of a user, wherein the plurality of bubbling features comprise (i) a bubble signal comprising time information and location information corresponding to the transportation plan, (ii) a supply and demand signal comprising transportation supply-demand information corresponding to the transportation plan, and (iii) a transportation order history signal of the user;
determining a discount signal according to the plurality of bubbling features and the current discount strategy; and
transmitting the discount signal to a computing device of the user.
